(19) United States
(12) Patent Application Publication
(10) Pub. No.: US 2013/0340614 A1
(43) Pub. Date: Dec. 26, 2013

(54) NOVEL ADSORBENT COMPOSITIONS

(71) Applicants: PHILIP ALEXANDER BARRETT, TONAWANDA, NY (US); STEVEN JOHN PONTONIO, EDEN, NY (US); PERSEFONI KECHAGIA, WILLIAMSVILLE, NY (US); NEIL ANDREW STEPHENSON, EAST AMHERST, NY (US)

(72) Inventors: PHILIP ALEXANDER BARRETT, TONAWANDA, NY (US); STEVEN JOHN PONTONIO, EDEN, NY (US); PERSEFONI KECHAGIA, WILLIAMSVILLE, NY (US); NEIL ANDREW STEPHENSON, EAST AMHERST, NY (US)

(21) Appl. No.: 13/530,236

(22) Filed: Jun. 22, 2012

(51) Int. Cl. B01J 20/18; B01D 53/047; B01D 53/02

(52) U.S. Cl. 95/96; 95/90; 502/64

(57) ABSTRACT

Adsorbent compositions useful in adsorption, separation and purification processes are made using silicone-derived binding agents. The adsorbent compositions having enhanced adsorption rate and crush strength properties are made from agglomerated crystallite particles bound with silicone-derived binding agents. The silicone binder precursors are calcined during the manufacturing process to produce the silicone-derived binding agents. The adsorbent compositions are preferably used in air separation processes.

### FIELD OF THE INVENTION

The present invention is directed to novel adsorbent compositions useful in adsorption, separation, and purification processes. More particularly, the invention is directed to adsorbents made from agglomerated crystallite particles bound with silicone-derived binding agents. The present adsorbents have superior pore structures, superior crush strengths and exhibit enhanced adsorption rate properties, especially when used in gas separation processes.

### BACKGROUND OF THE INVENTION

The adsorbents of this invention are useful in the adsorption, separation and purification of fluids such as the separation of gases. Typically the adsorbent compositions are used in processes for separating a less strongly adsorbable component from a fluid mixture containing at least one less strongly adsorbable component and at least one more strongly adsorbable component by contacting the fluid mixture with an adsorbent composition which selectively adsorbs the at least one more strongly adsorbable component and the at least one less strongly adsorbable component is recovered as product.

Of particular interest is the use of these adsorbents in non-cryogenic gas separation processes. For example, the separation of nitrogen from gas mixtures is the basis for several industrial adsorption processes, including the production of oxygen from air. In the production of oxygen from air, air is passed through an adsorbent bed having a preference for the adsorption of nitrogen molecules (more strongly adsorbable component) and leaving oxygen and argon (less strongly adsorbable components) to be produced. The adsorbed nitrogen is then desorbed through a purging step, normally through a change in pressure, including vacuum, or through temperature changes to regenerate the adsorbent and the cycle is repeated. Such processes include pressure swing adsorption (PSA), temperature swing adsorption (TSA), vacuum swing adsorption (VSA) and vacuum pressure swing adsorption (VPSA) processes and such processes are commonly used in commercial air separation operations as well as in other industrial processes.

Clearly the particular adsorbent used in these processes is an important factor in achieving an efficient, effective and competitive process. The performance of the adsorbent is dependent on several factors, including the adsorption capacity for the more strongly adsorbable component, the selectivity between fluids, which will impact the production yield, the adsorption kinetics, which will enable the adsorption cycle times to be optimized to improve the productivity of the process. The crush strength/attrition rate of the agglomerated particles is also very important particularly with respect to achieving a satisfactory adsorbent life in the adsorption process and system. Many of these factors are directly dependent on the particle pore structure and pore architecture.

The present invention is directed to novel adsorbent compositions, hereinafter adsorbents, and particularly agglomerated adsorbent particles composed of at least one active component and a silicone-derived binding agent. The adsorbents are engineered during the manufacturing process to enhance their adsorption rate (kinetic) properties through improved composition (i.e. very high active phase concentration) and pore-structure architecture. Such adsorbents have high crush strength values and higher adsorption rate properties and are especially enabling for PSA/TSA/VSA/VPSA process intensification, a term commonly used to describe fast cycles with high rate adsorbents. When effectively used in these adsorption processes, such adsorbents lead to lower capital costs, reduced power consumption and/or increased product recovery.

Conventional agglomerated adsorbents used for adsorption, separation and purification processes are composed of zeolite powders (crystallite particles), optionally ion exchanged zeolite powders depending on the process and binding agent. The binding agent is intended to ensure the cohesion of the agglomerated particles which are generally in the form of beads, pellets, extrudates, as well as other geometries. Binding agents generally have no adsorbing property and their only function is to give the agglomerated particles sufficient mechanical strength to withstand the rigors of deployment in packed bed adsorption systems and the vibrations and stresses to which they are subjected to during the particular adsorption process such as pressurization and depressurization. The particular binding agent and its concentration impact the final pore structure of the agglomerated particles thereby affecting the adsorbent's properties. It is known that the binding agent concentration should be low to lower mass transfer resistances that can be negatively impacted from excess binder being present in the pores.

One of the most common methods to obtain agglomerated adsorbent particles with low binder concentrations, improved pore architectures and low mass transfer resistances is to use the caustic digestion method to prepare binderless adsorbents. Binderless adsorbents represent one approach to obtain a low binder content, but at the expense of additional manufacturing steps and cost. The conventional approach for caustic digestion is to employ clay binding agents that can be converted to active adsorbent material via the caustic treatment. Several prior disclosures have claimed novel pore structures and demonstrated various levels of improvement to the adsorption rate properties from the use of these binderless adsorbents. For instance, U.S. Pat. No. 6,425,940 B1 describes a high rate adsorbent made substantially binderless and having a median pore diameter>0.1 μm and in some cases a bimodal pore distribution having larger 2-10 micron pores engineered by using combustible fibers such as nylon, rayon and sisal, added during the forming process.

In U.S. Pat. No. 6,652,626 B1, a process for producing agglomerated bodies of zeolite X is described wherein a binder containing at least 80% of a clay convertible to zeolite is contacted after calcination with a caustic solution to obtain an agglomerated zeolite material composed of at least 95% of an Li exchange zeolite X, having an Si/Al=1. The products are reported to have N₂ capacities at 1 bar, 25° C.≧26 ml/g. No pore structure or diffusivity information is disclosed.

In U.S. Patent Application Publication No. 2011/104494, a zeolite based adsorbent granulate is disclosed, comprising a zeolite of the Faujasite structure and having a molar SiO₂/Al₂O₃ ratio≧2.1-2.5. The adsorbent granulate has a mean transport pore diameter of >300 nm and a mesopore fraction of <10% and preferably <5%. The adsorbent granulate is prepared by mixing an X-type zeolite with a thermally treated kaoline clay in the presence of sodium silicate, sodium aluminate and sodium hydroxide.

A significant drawback to the manufacture of these binderless adsorbents is their high manufacturing cost due to additional processing steps, reagents and time required for the binder conversion. Another disadvantage of making binderless adsorbents stems from the need to handle, store and dispose of large quantities of the highly caustic solutions required in the adsorbent manufacturing process. This adds costs and environmental concerns to the process.

Another class of prior adsorbents teaches novel pore architectures through the use of novel binding agents or traditional binding agents with improved agglomeration processing. However from the disclosures in this latter class of prior teachings, the degree of performance improvement is inferior to binderless adsorbent types. Moreover, lower crush strengths and the associated lower cohesive strength as well as high levels of abrasion losses result from some of these binding agents or from the use of low concentrations of the binding agents.

A variety of binding agents are taught. U.S. Pat. No. 6,171,370 B1 discloses an adsorbent showing utility in a PSA process which is characterized by having macropores with average diameter greater than the mean free path of an adsorbable component, when desorbing said component, and wherein at least 70% of the macropore volume is occupied by macropores having a diameter equal to or greater than the mean free path of the adsorbable component. The use of clay binders including attapulgite and sepiolite in concentrations of 5-30 wt % is described.

U.S. Pat. No. 8,123,835 B2 describes the use of colloidal silica binders to produce superior adsorbents for gas separation applications including air separation. This teaching uses colloidal silica binding agents yielding macropores substantially free of binding agent. The adsorbents are characterized by an adsorption rate, expressed in the form of size compensated relative rate/porosity, of at least 4.0 mmol mm²/g s. The binder content is less than or equal to 15 wt % and the mean crush strength is greater than or equal to 0.9 lbF measured on particles having a mean size of 1.0 mm. However, no examples of adsorbents are shown having concentrations of active material of at least 93 wt % in the final product and a crush strength of greater than 1.0 lbF as measured on particles of 1.0 mm mean size.

It is therefore desirable to obtain adsorbents with high adsorption rates incorporating low concentrations of binding agents which can be made using less costly and more traditional manufacturing processes. It is further desirable to be able to obtain adsorbents with good crush strength and attrition resistance properties at such low binder concentrations.

The present adsorbents achieve these objectives by the use of silicones as the binder precursor which, at the end of the adsorbent manufacturing process, becomes a novel class of binding agent. The use of silicones as the binder precursor has the surprising effect of producing agglomerated adsorbent particles with superior pore structures, excellent adsorption rates and high crush strength properties; all at low binder concentrations. These adsorbents can be made using traditional manufacturing methods and equipment, including accretion methods, pan-granulation, extrusion and mixer forming processes, including Nauta-forming.

### BRIEF SUMMARY OF THE INVENTION

The present invention provides superior agglomerated adsorbent compositions useful in adsorption, separation, and purification processes including cyclic gas separation processes such as air separation. These adsorbents are comprised of active adsorbent materials such as aluminosilicate powders or crystallites which are agglomerated using low concentrations of a silicone-derived binding agent. The agglomerated particles exhibit high crush strength values, superior pore structures and connectivity, and enhanced adsorption rate properties.

In one embodiment, an adsorbent composition is provided that is prepared by the heat treatment of a mixture of at least one active material and a silicone-derived binding agent to form agglomerated particles comprised of 93% or more of the at least one active material calculated on a dry weight final product basis and having a crush strength value of greater than that obtained from the value determined by the relationship y=1.2x−0.2 where y is the mean crush strength in lbF and x is the mean particle size in mm. Further, the adsorbent composition comprising the agglomerated crystallite zeolite particles bound with a silicone-derived binding agent and derived from the calcination of a mixture of the crystallite zeolite particles with a silicone binder precursor has substantially no visible silicone-derived binding agent in the pores of the particles created by the stacking of the crystallite zeolite particles when viewed under an SEM microscope at 4500× magnification.

In another embodiment, an adsorption process for separating a less strongly adsorbable component from a fluid mixture containing at least one less strongly adsorbable component and at least one more strongly adsorbable component is provided comprising contacting the fluid mixture with an adsorbent composition which selectively adsorbs the at least one more strongly adsorbable component and the at least one less strongly adsorbable component is recovered as product; the adsorbent composition comprising agglomerated particles of at least one active component bound together by a silicone-derived binding agent and wherein 93% or more of the active component is present calculated on a dry weight final product basis and the composition has a crush strength value of greater than that obtained from the value determined by the relationship y=1.2x−0.2 where y is the mean crush strength in lbF and x is the mean particle size in mm.

In another embodiment, an agglomerated adsorbent composition useful in adsorption, separation, and purification processes is prepared by the process of mixing at least one active component selected from one or more aluminosilicates and a silicone binder precursor containing organic side groups on an silicon-oxide backbone to make a mixture, forming the mixture into agglomerated particles, and subjecting the agglomerated particles to a thermal heat treatment sufficient to volatize at least part of the organic side groups to form a silicone-derived binding agent, wherein the silicone-derived binding agent is present in the final agglomerated adsorbent composition in an amount of 10% or less calculated on a dry weight final product basis.

In yet another embodiment, an adsorbent composition that has been prepared by the heat treatment of a mixture of one or more aluminosilicates and a silicone-derived binding agent to form agglomerated particles is provided wherein the composition is characterized by a median pore diameter of equal to or greater than 0.45 μm, 10% or less of the macropores and mesopores are of less than or equal to 0.1 μm, a hysteresis factor of equal to or greater than 0.5, and a crush strength value of greater than or equal to 1 lbF as measured on particles of 1.0 mm mean size.

### BRIEF DESCRIPTION OF THE DRAWINGS

FIG. 1 is a set of 4 Scanning Electron Microscope images each showing a cross section of an adsorbent bead made using a conventional binding agent (a) and (b) and the silicone derived binding agent of the present invention (c) and (d).

FIG. 2 is a graph showing the limiting crush strength versus mean particle size for compositions using conventional binding agents compared to the silicone derived binding agent of the present invention.

### DETAILED DESCRIPTION OF THE INVENTION

The present invention is directed to superior adsorbent compositions which are preferably shaped into agglomerates and used in adsorption, separation, and purification processes such as the separation of fluids, preferably gases. They are particularly useful for the separation of gas mixtures by the adsorption of a more strongly adsorbable gas from a gas mixture containing the more strongly adsorbable gas and a less strongly adsorbable gas, including but not limited to, the purification of hydrogen by the adsorption of CO and/or N₂, the separation of certain gaseous paraffins (alkanes) or olefins (alkenes) from gas mixtures, air separation for the production of oxygen and air prepurification by removal of H₂O, CO₂ and other contaminants including N₂O and hydrocarbons. Preferred are processes requiring adsorbents having high adsorption capacities, high adsorption rates, high crush strength values and attrition resistance, and which can withstand the demands of packed bed adsorption processes including pressurization/depressurization stresses.

As more specifically described herein, but not intending to be limited hereto, the adsorbents are preferably used in cyclic adsorption processes for the separation of gases such as PSA, TSA, VSA, or VPSA processes or a combination thereof. These processes are exemplified by the production of oxygen from air by the adsorption of nitrogen although other adsorption processes can be conducted.

PSA, TSA, VSA or VPSA units or systems separate gas species from a mixture of gases under elevated pressure and/or temperatures according to the gas species' molecular characteristics and affinity for the adsorbent. The feed air is passed through a first porous bed packed with the adsorbent material which adsorbs the target gas species (e.g. nitrogen) at higher pressures and then the process reverses to a lower pressure and process gas is used to purge and desorb the gas species (e.g. nitrogen) from the adsorbent material in the bed. Typically, this process alternates between two or more beds maintaining a continuous operation although single bed systems are known. The steps in a multi-bed air separation adsorption cycle generally include: (1) adsorption (feed) at high pressure, (2) countercurrent blowdown to lower pressure or vacuum, (3) countercurrent purge with a gas relatively free of impurities, and (4) repressurization to higher pressure with either feed air or purified air. The regeneration of the adsorbents in the process is achieved by a combination of a simple reduction in pressure, including vacuum, and/or elevation of temperature and subsequent purge with an impurity-free gas. Any reactor or vessel configuration can be employed such as those having a radial or axial configuration.

The adsorbent compositions of this invention are derived from mixtures of at least one active component and the silicone binder precursor which after subsequent heat treatment transforms into the binding agent. The active components can include any material capable of performing the adsorption or separation functions for the selected application. Such materials are well known and generally include one or more natural and synthetic aluminosilicates, aluminas, and silicas. For example, zeolites, and other molecular sieves which are thermally stable (i.e. retain appreciable surface area as measured for instance by the established BET method see Chapter 3 in Analytical Methods in Fine Particle Technology, Paul A. Webb & Clyde Orr, Published by Micromeritics Instruments Corp., 1997 ISBN0-9656783-0-X) at the temperatures required to volatize the organic matter associated with the silicone binder precursor can be used as the active component. Preferred active components include one or more type X, Y, and A zeolites which may incorporate a wide variety of exchanged cations, such as Li, Ca, K, Na, Ag and mixtures thereof with lithium being preferred, exchanged into the lattice structure. More preferred are X zeolites having a SiO₂/Al₂O₃ ratio of less than 15, and even more preferred less than or equal to 2.5 such as X2.0 or LSX. Most preferred is LiLSX having a Li content of ≧95%. It is also preferred that the agglomerated composition has a mean particle size ranging from 0.4 mm to 5.0 mm.

Zeolites are particularly suitable as the active component since the manufacturing process can employ thermal treatments at temperatures of 400° C. or higher without degradation while permitting the conversion of the silicones to the form which acts as the binding agent. In general, adsorbents that have been agglomerated using traditional clay binders or other molecular silica binders, including colloidal silica binders, can be agglomerated using the silicones of the subject invention.

As described, silicones are used as the binder precursors which, during the course of adsorbent preparation, transform to a form or species which becomes the binding agent in the final composition. Silicones are synthetic compounds comprised of polymerized or oligomerized units of silicon together with predominately carbon, hydrogen and oxygen atoms. Silicones, also commonly known as siloxanes or polysiloxanes, are considered a hybrid of both organic and inorganic compounds since they contain organic side chains on an inorganic —Si—O—Si—O— backbone. Their structures can include linear, branched, cross-linked and cage-like variants.

Silicones have the general formula [R₂SiO]ₙ where R is one or more organic side groups selected from C1 to C8 organic compounds, preferably C1 to C4 organic compounds, including linear, branched and cyclic compounds or mixtures thereof and wherein the polymeric or oligomeric silicones are typically terminated by hydroxy, methoxy, ethoxy groups or mixtures thereof. The silicones of interest generally have molecular weighs ranging from about 100 to more than 500. The R side group can also represent other organic groups such as vinyl or trifluoropropyl and a wide range of silicones are believed to be useful in this invention.

Examples of silicones include, but are not limited to, polydimethylsiloxanes and polydiphenylsiloxanes such as those indentified by Chemical Abstracts Service (CAS) Registry Numbers 63148-62-9 and 63148-59-4 and those with di-methyl groups in polymeric forms with methyl, octyl silsesquioxanes such as CAS Registry Number of 897393-56-5 (available from Dow Corning under the designation IE 2404); methyl silsesquioxanes such as CAS Registry Number of 68554-66-5; and (2,4,4-trimethylpentyl) triethoxysilane such as CAS Registry Number 35435-21-3. Preferred silicones are selected from hydroxy, methoxy, or ethoxy terminated polymeric di-methylsiloxane or mixtures thereof with methyl-silsesquioxanes, octyl-silsesquioxanes, methyl octyl-silsesquioxanes, or mixtures thereof.

Silicones of more than one type can be used and the silicones can be used with other organic or inorganic compounds. Common additional components include water, co-polymer stabilizing agents, emulsifying agents and surfactants and silicone emulsions and suspensions can be employed as the silicone binder precursors. These additional components are often present to stabilize the particular form of the silicone which is typically used in the form of an emulsion, solution, or resin.

The typical manufacturing process to make adsorbents requires a heat treatment step generally known as calcination. Calcination is a thermal treatment intended to bring about one or more of; thermal decomposition, phase transition, or removal of volatile fractions (partial or complete) depending on the final material and its intended use. The calcination process is normally conducted in presence of air and takes place at temperatures below the melting point of the active component(s). The adsorbent compositions of this invention are prepared with a suitable thermal treatment process that is effective to remove part or all of the volatile matter associated with the silicone-derived binding agents.

During the heating process, the silicone binder precursor transforms into a species which becomes the binding agent for the adsorbent particles forming the agglomerate. As used herein, “silicone-derived binding agent” is intended to describe the silicone species that has undergone sufficient thermal or heat treatment to have volatilized part or all of the organic side groups associated with the starting silicone binder precursor and leaving a silicon-containing binder residue. It is believed that the silicones are transformed by the heat treatment into a new silicon containing species having a modified chemical composition which is extremely effective as binding agents for adsorbent particles, especially zeolite containing compositions, and provide sufficient strength to the agglomerates at concentrations of 10% or less, preferably 7% or less, and more preferably 5% or less calculated on a dry weight final product basis. It is believed that part or all of the organic side groups are lost while the residual inorganic Si and O atom backbone is substantially retained serving as the core of the binding agent for the adsorbent particles. This silicone-derived binding agent has been found to work as an exceptional binding agent for the adsorbent particles and is capable of yielding agglomerated particles having crush strengths of greater than 1 lbF as measured on particles of 1.0 mm mean size using the individual bead crush strength method.

For the purposes of this invention, the term mean particle size is that which is determined from a standard screening analysis, using U.S.A Standard mesh screens with the weight of sample retained on each screen determined and corrected back to a dry weight basis using an Loss on Ignition (LOI) measurement or other suitable means. The term “mesh” is understood to be U.S.A. Standard mesh. For crush strength measurements, a 1.0 mm mean particle size sample can be prepared by combining equal weight fractions (dry weight basis) of particles having size 16×18 mesh and 18×20 mesh. In this designation of 16×18 mesh or 18×20 mesh, it is understood that the particles pass through the first screen and are retained on the second screen (i.e. for 16×18 mesh the particles pass through the 16 mesh screen and are retained on the 18 mesh screen). All crush strength measurements are either measured herein on particles of 1.0 mm mean size prepared using the screening method described above, or if measured at particle sizes other than 1.0 mm mean size, are compared against the value obtained, at equivalent mean particle size, as calculated by the formula y=1.2x−0.2 (where y=the crush strength in lbF and x is the mean particle size in mm) which has been derived to account for the dependence of crush strength on mean particle size (see below). Preferred adsorbents of the present invention will have crush strengths above the limiting value, for any given particle size, as calculated from the formula above. Adsorbents having these silicone-derived binding agents also show exceptional attrition resistance at these low binder concentrations (post calcination) which reduces both loss of active material and equipment malfunction/cleaning.

Agglomerated adsorbent particles made with the silicone-derived binders have pore structure characteristics that differ from those found in adsorbents made with colloidal silicas, conventional clay binders, or other inorganic based binders. For example, adsorbents made using colloidal silica binding agents continue to exhibit a measurable amount of undesirable small pores (i.e. pores less than 0.1 μm) which are generally absent in the adsorbents made with the silicone-derived binding agents. In addition, the crush strength and attrition resistance of adsorbents prepared with the silicone-derived binding agents are significantly improved compared to similarly produced adsorbents made with other binders at similar concentrations and the adsorption capacity is very high and comparable with adsorbents made binderless using the more complex caustic digestion methods of manufacture. Finally, as a result of the refined pore structure obtained from the use of silicone-derived binding agents, the adsorption kinetics are surprisingly enhanced versus traditional adsorbents bound with clay binders.

A generalized method to prepare the adsorbents of the present invention is as follows. One or more active components is mixed with the silicone binder precursors and with any other processing aids, such as extrusion aids, solvents (i.e. water), plasticizers, pore formers and/or temporary binders. It is preferred that the blending of the adsorbent components be thorough, such that the final product is consistent in terms of appearance and other properties, such as loss on ignition and viscosity. High intensity or high shear mixing equipment is particularly preferred from the standpoint of obtaining a mixed product with a high level of consistency and homogeneity. However, other mixing equipment which is capable of combining the components of the agglomerate formulation together, such that they are passable to the subsequent stages of manufacturing and ultimately result in products having the required physical and performance characteristics, can be used.

The binder concentration of the adsorbent material is determined by the standard McBain test (see e.g., Bolton, A. P., “Molecular Sieve Zeolites,” in Experimental Methods in Catalytic Research, Vol. II, ed. R. B. Anderson and P. T. Dawson, Academic Press, New York, 1976) using O₂ adsorption, on activated adsorbent samples, at 77K and 70 Torr by reference to a powder analogue of, the active component by itself, (i.e. in a non-agglomerated “binder-free” form). The output from the McBain test is the fractional amount of active component from which the binder content is defined as the difference in wt % O₂ adsorbed between the reference powder analogue and the final product relative to the reference powder analogue (i.e. (wt % O₂ adsorbed (powder analogue)−wt % O₂ (final product))/wt % O₂ (powder analogue) represents the fractional binder content. Multiplying this fractional binder content by 100 results in the wt % binder.

For purposes of the present invention, the procedure for carrying out the McBain test is as follows: The sample is air dried prior to the McBain test. It is then placed in the McBain apparatus and slowly dehydrated and activated under evacuation overnight, i.e. at a pressure of about 1×10⁻⁴ torr. The temperature is ramped from ambient to about 400° C. in eight hours and then held at this temperature for an additional eight hours. The sample is then cooled to liquid N₂ temperature (77K) and ultra high purity O₂ is introduced and maintained at a pressure of 70 torr until equilibrium is reached. The amount of O₂ adsorbed (wt %) is determined gravimetrically through an accurate measurement of the change in length of a calibrated helical spring. The measurement is repeated in the same way for the powder analogue reference sample and the binder content in wt % is calculated as described above.

For clarification, the binder content of prior clay-bound adsorbents, which are used herein for comparative purposes, is commonly reported as the fractional amount of clay contained within the mixture of adsorbent powder and clay binder on a dry weight basis. However, depending on whether or not compositional changing manufacturing steps (i.e. ion exchange) are used post agglomeration, the reported dry weight binder content may or may not be on a dry weight final product basis. This usual practice is retained for the purpose of the comparisons made with the invention. As a result of potential compositional changes after the agglomeration step, the reported binder content for clay binder containing samples may be different to that measured by the McBain standard method described above. After the components have been blended together, they are ready for agglomeration into particles, which are preferred for packed bed type applications. Examples include beads, pellets, tablets, extrudates and granules. Depending on the form of the adsorbent required (i.e. bead or extrudate), an appropriate piece of equipment is used. For the beaded type products which are preferred for most packed bed adsorption processes, accretion wheels, mixers, and rotating pans are all acceptable devices for agglomeration. The purpose of the agglomeration step is to make agglomerates having sizes which meet the needs of the application (typically from about 0.4 to 5 mm for most adsorption processes) and possessing sufficient strength, often called green strength, to survive any required additional processing steps, such as screening, as well as transportation to the next manufacturing operation. The agglomeration method and equipment can be any that accomplish the objective of obtaining agglomerate products with physical and performance characteristics which satisfy the criteria disclosed herein.

After agglomerates of the target particle size have been obtained from the agglomeration step, it is necessary to conduct the thermal treatment/calcination as described above to remove any removable components including volatile organic components, especially hydrocarbon groups, and convert the silicone binder precursor to the form that binds and adds strength to the agglomerated particles. Calcination is typically conducted at temperatures between about 300° C. and 600° C. Preferably, the thermal treatment is accomplished by staging the temperature rise from near ambient to greater than 400° C. in the presence of a suitable purge gas, such as dry air. The type of purge gas is not considered limiting and any purge gas which completes the objectives of the thermal treatment can be used. The thermal process removes any removable species, conditions the adsorbent for use (e.g. lowers the residual moisture content to values of ≦1 wt % as measured by a suitable technique such as the Karl Fischer titration method (see U.S. Pat. No. 6,171,370)) in the final process and systems, and strengthens the agglomerated particles to meet the crush strength specification. Any oven type, furnace type or kiln type can be used.

This basic manufacturing method for the adsorbents can be augmented by additional steps or stages as dictated by the adsorbent type and intended application. Examples of common additional processing steps include, but are not limited to, ion exchange processes for zeolites and aging steps for aluminas and silicas.

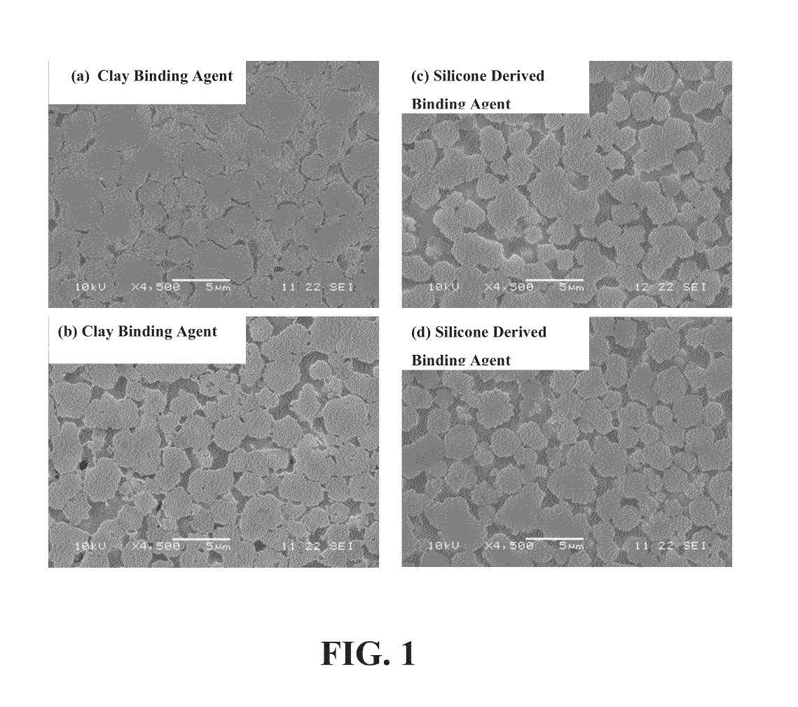

The products obtained from the above manufacturing process are agglomerated adsorbent particles having particle diameters in the 0.4 to 5.0 mm size range. The resulting agglomerated adsorbents have high adsorption capacities and fast adsorption rates and rival if not surpass the binderless zeolite adsorbents of equivalent type as made by the more complex and expensive caustic digestion processes. Low silicone-derived binding agent concentrations of 10 wt % or less, preferably 7 wt %, and more preferably 5 wt % or less can be used with the final adsorbents and still exhibit the superior crush strength and attrition resistance while having high concentrations of active material. A final silicone-derived binding agent content of 10 wt % or less, 7 wt % or less, and 5 wt % or less results in an active component fraction of 90 wt % or more, 93 wt % or more and 95 wt % or more, respectively in the agglomerated adsorbent. The more active component fraction in the adsorbent, with the correct adsorption characteristics, will result in a higher rate material. Traditional clay bound products using similar manufacturing processes generally require binder concentrations of over 10 wt % and, more commonly at least 15 wt %, to achieve sufficient crush strength and attrition resistance resulting in lower concentrations of active component in the final composition. FIGS. 1a-d are a set of 4 Scanning Electron Microscope images each showing a cross section of an LiLSX adsorbent bead made using either a clay binding agent (a) and (b) or a silicone derived binding agent of the present invention (c) and (d) at 4500× magnification. The SEM images are “true” cross-sections of the agglomerated particles and pores greater than about 0.05 μm can be seen at this magnification. The consistent “binder-free” nature of the macropores is apparent for the silicone-derived binder sample.

In FIG. 1(a), the clay binder is clearly visible as a fibrous particulate, lying in between the crystallites of the adsorbent and can be clearly seen to result in a region of low porosity as a result of the clay binding agent filling the pores that result from the stacking of the adsorbent crystallites. In FIG. 1(b) a different area of the bead is represented still showing some binding agent filling in the pores, resulting from the stacking of the adsorbent crystallites, albeit to a lesser extent. Without wishing to be bound by theory, it is believed that these “dense” clay binder rich and “porous” clay depleted regions coexist within a single agglomerated adsorbent particle, serve to create less desirable pore structures, and as a result, slower adsorption kinetics.

In the case of adsorbent bound with silicone-derived binding agents as shown in FIGS. 1(c) and 1(d), the location of the binding agent is not clearly identifiable suggesting that the new silicone-derived species formed during the heat treatment which is binding the particles are of small particle size. Again not intending to be bound to theory, it is believed that this new silicone-derived species forms clusters or (partial-porous) coatings on the adsorbent crystallite surfaces forming contact points for the binding of one crystallite to another. Since the pores of the inventive adsorbent are overwhelmingly free of binding agent, pore structure improvements are seen as expressed in the median pore diameter, percent of small pores and pore connectivity characteristics.

Three parameters are used to provide a more detailed view of the adsorbent pore structure of the inventive adsorbents; namely the median pore diameter, the fraction of pores that are ≦0.1 μm and a hysteresis parameter representing pore connectivity. These parameters are all measured and obtained from the standard Hg porosimetry techniques. The median pore diameter is known to support pore structures having improved characteristics (e.g. see, U.S. Pat. No. 6,425,940 B1). The second parameter is the fraction of small pores, denoted F (see Equation 2), and is a measure of the amount of rate or mass transfer limiting small macropores and mesopores present in the agglomerated adsorbent particles, which are determinable by the Hg porosimetry technique. With reference to Equation 2, I (60,000 psia) is the cumulative intrusion volume at 60,000 psia, I (2 psia), is the cumulative intrusion volume at 2 psia and I (1,900 psia) is the cumulative intrusion volume at 1,900 psia. As defined herein, F is a measure of the fraction of pores of pores of size≦0.1 μm and has also been used in the prior art to indicate the novelty of an agglomerate pore structure (e.g. see, U.S. Patent application 2011104494 and U.S. Pat. No. 6,171,370 B1 where the detrimental impact of large fractions of these small macropore and mesopore transport pores are taught). The third parameter is the hysteresis factor “R” which has been defined from standard Hg porosimetry data as shown in Equation 1 wherein: I (60,000 psia) is the cumulative intrusion volume at 60,000 psia from the intrusion curve, I (50 psia) is the cumulative intrusion volume at 50 psia from the intrusion curve and E (50 psia) is the cumulative intrusion volume at 50 psia from the extrusion curve.

$$\begin{matrix}R = \frac{{V}_{E}}{{V}_{I}} = \frac{I ( 60 , 000 psia ) - E ( 50 psia )}{I ( 60 , 000 psia ) - I ( 50 psia )} & ( 1 ) \\ F = ( 1 - \frac{I ( 1 , 900 psia ) - I ( 2 psia )}{I ( 60 , 000 psia ) - I ( 2 psia )} ) \times 100 & ( 2 )\end{matrix}$$

The pore structure characteristics of the present agglomerated adsorbents are as follows: the median pore diameter of equal to or greater than 0.45 μm. 10% or less of the macropores/mesopores are less than or equal to 0.1 μm, and the hysteresis factor is equal to or greater than 0.5. The use of intrusion and extrusion data from Hg porosimetry to determine pore structure and connectivity information, such as the presence or absence of ink-bottle pores, is well known and described in text books on this subject (see Chapter 4 in Analytical Methods in Fine Particle Technology, Paul A. Webb & Clyde Orr, Published by Micromeritics Instruments Corp., 1997 ISBN0-9656783-0-X). From the perspective of a preferred pore structure and connectivity, the larger the value of the hysteresis factor R for an agglomerate towards a maximum of 1, the better since, this equates to a more homogeneous pore architecture without ink-bottle and other less desirable pores morphologies. From the standpoint of defining the pore structure of the agglomerated adsorbents disclosed herein, a high value for the median pore diameter, a low fraction (F) of pores less than or equal to 0.1 μm and a high hysteresis factor (R) are preferred. Finally, the preferred adsorbent particles of the present invention will have crush strength values, as measured by the single bead method, of greater than 1 lbF at 1.0 mm mean particle size and an attrition rate below 1%, preferably 0.75%. A simple equation is established to account for the dependence of the crush strength value on the mean particle size of the bead or agglomerated particle. According to this equation, the agglomerated particles will have a crush strength value greater than that obtained from the value determined by the relationship of y=1.2x−0.2 where y is the mean crush strength in lbF and x is the mean particle size in mm. Percent attrition is determine as the amount of product passing a U.S.A. Standard 25 mesh screen after 60 minutes of agitation using 100 g of calcined material prescreened to greater than 25 mesh in a Ro-tap® Sieve Shaker model RX-29 equipped with 8″ diameter screens.

In Table 1, characteristics for representative LiLSX zeolite adsorbents made using traditional clay binders and the silicone-derived binding agents of the present invention are shown. A representative binderless adsorbent is also provided for comparison prepared by the caustic digestion method as taught in U.S. Pat. No. 6,425,940 B1. The pore diffusivity (Dₚ) as determined using the method and equipment described in U.S. Pat. No. 6,500,234 B1 and U.S. Pat. No. 6,790,260 B2 is also given in Table 1.

TABLE 1
Pore Structure Parameters from Hg Porosimetry and Nitrogen Pore Diffusivity
(D_{P}) for LiLSX Adsorbents made with Clay and Silicone-Derived Binding Agents

| | | Binder | | Median | % of | | |
|---|---|---|---|---|---|---|---|
| | Binder | Content | Porosity | Pore Dia. | Pores ≦ | Hysteresis | |
| Sample | Type | (wt %) | (%) | (μm) | 0.1 μm | Factor R | Dₚ (m²/s) |
| I. | Silicone - | 5 | 38 | 0.52 | 7.1 | 0.7 | 4.5 × 10⁻⁶ |
| | derived | | | | | | |
| II. | Clay | 7 | 38 | 0.33 | 25.4 | 0.4 | 2.5 × 10⁻⁶ |
| III. | Binderless | N/A | 36 | 0.90 | 9.1 | 0.2 | 3.9 × 10⁻⁶ |

I. See Example 4 for preparation details
II. Sample from commercial supplier from Zeochem, LLC
III. Sample prepared as described in U.S. Pat. No. 6,425,940 B1

From the data in Table 1, it is evident that the LiLSX zeolite adsorbent with the silicone-derived binding agent has the best combination of a high median pore diameter, a lower percentage of pores≦0.1 μm and an improved hysteresis factor compared to the other samples. The median pore diameter for the binderless sample is the highest of the three samples, yet the N₂ pore diffusivity is inferior to the silicone-derived sample, indicating an inferior adsorption rate. The hysteresis factor is also lower for the binderless sample indicating a less effective pore architecture. The three parameters from the Hg porosimetry measurement defined in combination represent a more complete view of the actual pore architecture and are good predictors of the adsorption rate, compared to any of the parameters used in isolation. The adsorbents with the silicon-derived binding agents clearly exhibit a superior pore architecture.

Finally, adsorbents made using the silicone-derived binding agents exhibit high adsorption rates as measured by nitrogen pore diffusivity (Dₚ, a measure of adsorption rate). The agglomerated adsorbent particles of this invention exhibit a Dₚ of greater than 4.0×10⁻⁶ m²/s. This compares to adsorbents particles bound with conventional clay binders with a Dₚ of less than 3.0×10⁻⁶ m²/s and the binderless adsorbent particles with a Dₚ of 3.9×10⁻⁶ m²/s. The following Examples demonstrate the differentiated features of the inventive adsorbents from adsorbents made from conventional binders including clays and colloidal silica bound products. The Examples are provided at 7 wt % silicone-derived binding agent and less. Useful adsorbents can be prepared at higher binder concentrations, including 10 wt % silicone-derived binding agent. Increasing the binder concentration will provide improved physical characteristics especially the crush strength, as is understood by one skilled in the art. At a binder concentration of up to 10 wt %, the improvements to Dₚ, median pore diameter, percentage of pores≦0.1 μm and hysteresis factor described herein, will be achieved versus the traditional clay and colloidal silica binding agents described in the prior art. At 10 wt % binding agent, the active phase concentration of 90% is still high versus many traditional prior art compositions. At binder concentration of greater than 10 wt %, the benefit of high active phase concentrations, offered by the present invention, diminish.

### Example 1

### NaKLSX Zeolite Adsorbent with 7 wt % Silicone-Derived Binding Agent

2000.0 g of zeolite NaKLSX powder on a dry weight basis (2684.6 g wet weight) were mixed with 60 g F4M Methocel in a Hobart mixer for 10 minutes. Thereafter with the mixer still agitating, 467.5 g of IE-2404 (a silicone containing silicone resin emulsion from Dow Corning) was pumped in at rate of 15 ml/min. After the IE-2404 addition was completed, mixing was continued for an additional 1 hour, before the now mixed products were transferred to a Nauta mixer having internal volume ˜1 ft³ and agitated therein at a speed of 9 rpm. The Nauta mixing was continued, while gradually adding deionized water to form beads having porosity in the range 35-40%, as measured after calcination using a Micromeritics Autopore IV Hg porosimeter. At the end of this mixing time, beads including those in the target 12×16 mesh size range had formed. The product beads were air dried overnight prior to calcination using a shallow tray method at temperatures up to 593° C. The shallow tray calcination method used a General Signal Company Blue M Electric oven equipped with a dry air purge. The adsorbents were spread out in stainless steel mesh trays to provide a thin layer less than 0.5 inch deep. A purge of 200 SCFH of dry air was fed to the oven during calcination. The temperature was set to 90° C. followed by a 360-minute dwell time. The temperature was then increased to 200° C. gradually over the course of a 360-minute period (approximate ramp rate=0.31° C./min), and then further increased to 300° C. over a 120-minute period (approximate ramp rate=0.83° C./min) and finally increased to 593° C. over a 180-minute period (approximate ramp rate=1.63° C./min) and held there for 45 minutes before cooling. The calcined beads were subjected to a screening operation to determine the yield and harvest those particles in the 12×16 mesh size range.

### Example A (Comparative)

### NaKLSX Zeolite Adsorbent with 7 wt % Colloidal Silica Binding Agent

2000.0 g of zeolite NaKLSX powder on a dry weight basis (2684.6 g wet weight) were mixed with 60 g F4M Methocel in a Hobart mixer for 10 minutes. Thereafter with the mixer still agitating, 376.4 g of Ludox HS-40 colloidal silica (from Dow Chemical) was pumped in at a rate of 17 ml/min. After the colloidal silica addition was completed, mixing was continued for an additional 1 hour, before the now mixed products were transferred to a Nauta mixer having internal volume ˜1 ft³ and agitated therein at a speed of 9 rpm. The Nauta mixing was continued, while gradually adding deionized water to form beads having porosity in the range 35-40%, as measured after calcination using a Micromeritics Autopore IV Hg porosimeter. At the end of this mixing time, beads including those in the target 12×16 mesh size range had formed. The product beads were air dried overnight prior to calcination using the shallow tray method at temperatures up to 593° C., as described in Example 1. The calcined beads were subjected to a screening operation to determine the yield and harvest those particles in the 12×16 mesh size range.

### Example B (Comparative)

### NaKLSX Zeolite Adsorbent with 7 wt % Clay Binding Agent

2000.0 g of zeolite NaKLSX powder on a dry weight basis (2684.6 g wet weight) were mixed with 150.5 g Actigel 208 on a dry weight basis (195.5 g wet weight) and 60.0 g F4M Methocel in a Hobart mixer for 1 hour and 35 minutes. The product from the Hobart was transferred to a Nauta mixer having internal volume ˜1 ft³ and agitated therein at a speed of 9 rpm. The Nauta mixing was continued, while gradually adding deionized water to form beads having porosity in the range 35-40%, as measured after calcination using a Micromeritics Autopore IV Hg porosimeter. At the end of this mixing time, beads including those in the target 12×16 mesh size range had formed. The product beads were air dried overnight prior to calcination using the shallow tray method at temperatures up to 593° C., as described in Example 1. The calcined beads were subjected to a screening operation to determine the yield and harvest those particles in the 12×16 mesh size range.

TABLE 2
Pore Structure Parameters for Examples 1, A and B

| | | ¹Av. | | | ²% | ²Hysteresis | ³Crush | |
|---|---|---|---|---|---|---|---|---|
| | Binder | Particle | ²Porosity | ²MPD | Pores ≦ | Factor R | Strength | ⁴Attrition |
| Sample | Type | Size (mm) | (%) | (μm) | 0.1 μm | (Dim.) | (lbF) | (wt %) |
| 1 | Silicone- | 1.75 | 35.2 | 0.88 | 7.1 | 0.8 | 3.4 | 0.3 |
| | derived | | | | | | | |
| A | Coll. | 1.75 | 32.4 | 0.61 | 14.0 | 0.8 | 0.6 | 1.6 |
| | Silica | | | | | | | |
| B | Clay | 1.73 | 39.6 | 0.56 | 16.2 | 0.4 | 0.8 | 1.1 |

¹Mean particle size is determined using a standard screening analysis method using 100 g of calcined material in a Ro-tap ® Sieve Shaker model RX-29 equipped with 8″ diameter U.S.A. Standard mesh screens using 15 minutes of agitation.
²Porosity, median pore diameter (MPD), % pores ≦ 0.1 μm and hysteresis factor are determined as described above from Hg porosimetry data.
³Crush strength is measured on calcined products by the single bead method, using 40 beads from which the mean crash strength is calculated. All crush strength measurements employed a Dr. Schleuniger Pharmatron Tablet Tester 8M equipped with a 50N load cell.
⁴Percent attrition is determine as the amount of product passing a U.S.A. Standard 25 mesh screen after 60 minutes of agitation using 100 g calcined material prescreened to greater than 25 mesh in a Ro-tap ® Sieve Shaker model RX-29 equipped with 8″ diameter screens.

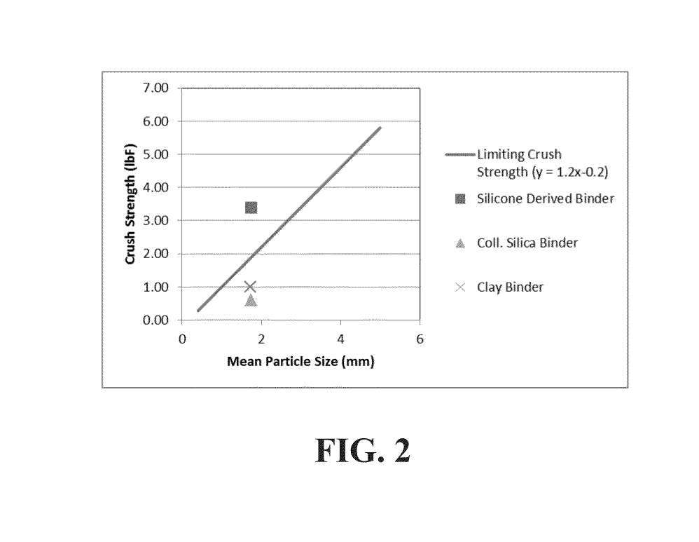

A side by side comparison of characteristics of the adsorbents of Example 1, an adsorbent with a silicone derived binding agent, Comparative Example A, a colloidal silica binding agent, and Comparative Example B, a traditional clay binder, is shown in Table 2. The three adsorbents had an equivalent particle size and binder content. The adsorbent with the silicone-derived binding agent yielded a 400% improvement in the crush strength compared to the other samples. The crush strength results for Example 1 and Comparative Examples A and B are plotted together in FIG. 2 and shown to exceed the limiting crush strength requirement calculated from the formula y=−1.2x−0.2 as defined above.

Similarly, the attrition resistance, a measure of the amount of dust formed by agglomerate-agglomerate particle contact, was also significantly improved with the silicone-derived binding agent being over 300% better than the closest comparative example, the adsorbent with the clay binder. With respect to the pore structure differences, the samples using colloidal silica binding agents and clay binding agents are characterized by a larger fraction of pores (about 200% more) having a diameter of less than or equal to 0.1 μm suggesting inferior adsorption kinetics. The pore structure information derived from the Hg porosimetry measurements confirms that the pore architecture of the macropores and mesopores of the silicone-derived adsorbent (Example 1) is clearly differentiated from the colloidal silica and clay comparative samples (A and B). The adsorbent of this invention has a median pore diameter of equal to or greater than 0.45 μm; less than 10%, preferably less than 8%, of its pores being less than or equal to 0.1 μm; and a hysteresis factor R of equal to or greater than 0.5.

### Example 4

### LiLSX Zeolite Adsorbent with 5 wt % Silicone-Derived Binding Agent

59.90 lbs. of zeolite NaKLSX powder on a dry weight basis (76.45 lbs. wet weight) were mixed with 0.60 lbs. F4M Methocel in a Littleford LS-150 plow mixer for 1 minute. Thereafter with the mixer still agitating, 9.8 lbs of IE-2404 (a silicone containing silicone resin emulsion from Dow Corning) was pumped in at rate of 1 lb/min. After the IE-2404 addition was completed, 11.0 lbs of water was added at a rate of 1 lb/min under constant stirring in the plow mixer. At the end of the water addition, plow mixing was continued for an additional 5 minutes. The plow mixed powder product labeled hereinafter “the formulation” was transferred to a tilted rotating drum mixer having internal working volume of ˜75 L and agitated therein at a speed of 24 rpm. Mixing of the formulation was continued while adding deionized water gradually to form beads. A recycling operation was performed, involving grinding-up and reforming the beads until beads having a porosity, measured using a Micromeritics Autopore IV Hg porosimeter on the calcined product, in the range 35-40% had formed. The product beads were air dried overnight prior to calcination using the shallow tray method at temperatures up to 593° C., described in Example 1.

The calcined beads were subjected to a screening operation to determine the yield and harvest those particles in the 16×20 mesh size range for further processing known in the art including steps of hydration, Li ion exchange and activation up to 593° C. under dry air purge. Li exchange of the samples (to an Li exchange level of at least 96% Li on an equivalents basis) was achieved using the following procedure: A column ion exchange process was used where the samples are packed inside a glass column (dimensions: 3-inch i.d.) contacted with lithium chloride solution (1.0 M) at 90° C. at a flow rate of 15 ml/min. A preheating zone before the adsorbent packed column, ensures the solution temperature has reached the target value prior to contacting the zeolite samples. A 12-fold excess of solution was contacted with the samples to yield products with Li contents of at least 96% exchange and above. After the required amount of solution is pumped through the column containing the samples, the feed is switched to de-ionized water to remove excess LiCl from the samples. A water volume of 50 L, a flow rate of 80 ml/min and a temperature of 90° C. was used. An AgNO₃ test, familiar to those skilled in the art, was used to verify that the effluent was essentially chloride free, at the end of the washing stage. The wet samples were dried and activated under dry Air purge (flow rate 200 SCFH) using the same procedure as the shallow tray calcination method described in Example 1 in a General Signal Company Blue M electric oven.

### Example 5

### LiLSX Zeolite Adsorbent with 5 wt % Silicone-Derived Binding Agent

2.80 lbs. of zeolite NaKLSX powder on a dry weight basis (54.60 lbs. wet weight) were mixed with 1.05 lbs. F4M Methocel in a Littleford LS-150 plow mixer for 1 minute. Thereafter with the mixer still agitating, 7.0 lbs. IE-2404 (a silicone containing silicone resin emulsion from Dow Corning) diluted with 7.0 lbs. water was pumped in at a rate of 1 lb./min. 20.5 lbs. of additional water was added gradually over a 1 hour 20 minute period with constant stirring in the plow mixer. Mixing was continued until beads having a porosity, measured using a Micromeritics Autopore IV Hg porosimeter on the calcined product, in the range 35-40% had formed. At the end of this mixing time, beads including those in the target 16×20 mesh size range had formed. The product beads were air dried overnight prior to calcination using the shallow tray method at temperatures up to 593° C., as described in Example 1. The calcined beads were subjected to a screening operation to determine the yield and harvest those particles in the 16×20 mesh size range for further processing to the Li ion exchanged and activated form as described in Example 4.

### Example 6

### LiLSX Zeolite Adsorbent with 4 wt % Silicone-Derived Binding Agent

43.20 lbs. of zeolite NaKLSX powder on a dry weight basis (55.15 lbs. wet weight) were mixed with 0.90 lbs. F4M Methocel in a Littleford LS-150 plow mixer for 1 minute. Thereafter with the mixer still agitating, 5.6 lbs. IE-2404 (a silicone containing silicone resin emulsion from Dow Corning) diluted with 5.6 lbs. water was pumped in at a rate of 1 lb./min. 20.9 lbs. of additional water was added gradually over a 26 minute period with constant stirring in the plow mixer. Mixing continued until beads having a porosity, measured using a Micromeritics Autopore IV Hg porosimeter on the calcined product, in the range 35-40% had formed. At the end of this mixing time, beads including those in the target 16×20 mesh size range had formed. The product beads were air dried overnight prior to calcination using the shallow tray method at temperatures up to 593° C., as described in Example 1. The calcined beads were subjected to a screening operation to determine the yield and harvest those particles in the 16×20 mesh size range for further processing to the Li ion exchanged and activated form as described in Example 4.

The products from examples 4-6 were characterized by Hg porosimetry to confirm that in each case the median pore diameter, percentage of pores≦0.1 μm and the hysteresis factor meet the criteria of the present invention. In addition, N₂ capacity and N₂ pore diffusivities have been obtained for representative samples to show that the adsorbents described herein are high performance products for applications such as non-cryogenic air separation. The N₂ capacity is determined at 760 Torr and 27° C. using a Micromeritics ASAP2050 Extended Pressure Sorption unit. The N₂ pore diffusivity (Dₚ) is calculated using the method and equipment described in Ackley et al U.S. Pat. No. 6,500,234 B1 and U.S. Pat. No. 6,790,260 B2.

TABLE 3
Characterization Results for Examples 4-6

| | | | | ¹% | ¹Hysteresis | | |
|---|---|---|---|---|---|---|---|
| | Binder | ¹Porosity | ¹MPD | Pores ≦ | Factor R | ²N₂ Cap. | ³Dₚ |
| Example | (%) | (%) | (μm) | 0.1 μm | (Dim.) | (mmol/g) | (m²/s) |
| 4 | 5 | 38.2 | 0.52 | 7.1 | 0.7 | 1.12 | 4.5 × 10⁻⁶ |
| 5 | 5 | 39.9 | 0.48 | 9.6 | 0.6 | 1.15 | 5.4 × 10⁻⁶ |
| 6 | 4 | 39.8 | 0.55 | 7.8 | 0.8 | — | — |

¹Porosity, median pore diameter (MPD), % pores ≦ 0.1 μm and hysteresis factor are determined as described above from Hg porosimetry data.
²N₂ capacity measured at 27° C., 760 Torr.
³Dₚ determined using the equipment and method described in Ackley et al U.S. Pat. No. 6,500,2,34 B1 and U.S. Pat. No. 6,790,260 B2.

### Example 7

### NaKLSX Zeolite Adsorbent with 5 wt % Silicone-Derived Binding Agent

2000.0 g of zeolite NaKLSX powder on a dry weight basis (2541.3 g wet weight) were mixed with 40 g F4M Methocel in a Hobart mixer for 10 minutes. Thereafter with the mixer still agitating, 198.3 g of MR-2404 (a silicone resin from Dow Corning) diluted with 5.6 lbs. water was pumped in at a rate of 20 ml/min. 1140.0 g of additional water was added gradually over a 2 hours and 30 minute period with constant stirring in the mixer. After the addition was completed, mixing was continued for a further 1 hour. After this time the products were transferred to a Nauta mixer having internal volume ˜1 ft³ and agitated therein at a speed of 9 rpm. The Nauta mixing was continued, while gradually adding deionized water to form beads having porosity in the range 35-40%, as measured after calcination using a Micromeritics Autopore IV Hg porosimeter. At the end of this mixing time, beads including those in the target 16×20 mesh size range had formed. The product beads were air dried overnight prior to calcination using the shallow tray method at temperatures up to 593° C., as described in Example 1.

### Example 8

### NaKLSX Zeolite Adsorbent with 7 wt % Silicone-Derived Binding Agent

2000.0 g of zeolite NaKLSX powder on a dry weight basis (2541.3 g wet weight) were mixed with 60 g F4M Methocel in a Hobart mixer for 10 minutes. Thereafter with the mixer still agitating, 460.34 g of BS45 (a silicone resin emulsion from Wacker Chemie AG) was pumped in at a rate of 15 ml/min. After the addition was completed, mixing was continued for a further 1 hour. The mixed formulation was then transferred to a Nauta mixer having internal volume ˜1 ft³ and agitated therein at a speed of 9 rpm. The Nauta mixing was continued, while gradually adding deionized water to form beads having porosity in the range 35-40%, as measured after calcination using a Micromeritics Autopore IV Hg porosimeter. At the end of this mixing time, beads including those in the target 16×20 mesh size range had formed. The product beads were air dried overnight prior to calcination using the shallow tray method at temperatures up to 593° C., as described in Example 1.

### Example 9

### NaKLSX Zeolite Adsorbent with 7 wt % Silicone-Derived Binding Agent

2000.0 g of zeolite NaKLSX powder on a dry weight basis (2535.2 g wet weight) were mixed with 289.4 g of 233 Flake Resin (a silicone containing silicone resin from Dow Corning) in a Hobart mixer for 5 minutes. Thereafter with the mixer still agitating, 300 g of deionized water was pumped in at a rate of 25 ml/min. After the addition was completed, mixing was continued for a further 1 hour. The mixed formulation was then transferred to a Nauta mixer having internal volume ˜1 ft³ and agitated therein at a speed of 9 rpm. The Nauta mixing was continued, while gradually adding deionized water to form beads having porosity in the range 35-40%, as measured after calcination using a Micromeritics Autopore IV Hg porosimeter. At the end of this mixing time, beads including those in the target 16×20 mesh size range had formed. The product beads were air dried overnight prior to calcination using the shallow tray method at temperatures up to 593° C., as described in Example 1.

### Example 10

### NaKLSX Zeolite Adsorbent with 7 wt % Silicone-Derived Binding Agent

2000.0 g of zeolite NaKLSX powder on a dry weight basis (2535.2 g wet weight) were mixed with 60.0 g F4M Methocel in a Hobart mixer for 1 hour. Thereafter with the mixer still agitating, 252.9 g of 233 Flake Resin (a silicone containing silicone resin from Dow Corning) dissolved in 379.0 g 2-Propanol was pumped in at rate of 14 ml/min. After the addition was completed, mixing was continued for 45 minutes. The mixed formulation was then transferred to a Nauta mixer having internal volume ˜1 ft³ and agitated therein at a speed of 9 rpm. The Nauta mixing was continued, while gradually adding deionized water to form beads having porosity in the range 35-40%, as measured after calcination using a Micromeritics Autopore IV Hg porosimeter. At the end of this mixing time, beads including those in the target 16×20 mesh size range had formed. The product beads were air dried overnight prior to calcination using the shallow tray method at temperatures up to 593° C., as described in Example 1.

### Example 11

### Zeolite 4A Adsorbent with 5 wt % Silicone-Derived Binding Agent

A batch comprising 2500.0 g of zeolite 4A powder on a dry weight basis (3088.8 g wet weight) were mixed with 25 g F4M Methocel in a Hobart mixer for 10 minutes. Thereafter with the mixer still agitating, 408.6 g IE-2404 (a silicone containing silicone resin emulsion from Dow Corning) was pumped in at a rate of 20 ml/min. After the addition was completed mixing was continued for 1 hour to conclude the preparation of batch 1. A further 3 batches were prepared in the same way and combined together and transferred to a tilted rotating drum mixer having an internal working volume of ˜75 L. The tilted rotating drum mixer was then rotated at a speed of 24 rpm. The formulation was mixed continuously, while gradually adding deionized water to form beads having porosity in the range 35-40%, as measured after calcination using a Micromeritics Autopore IV Hg porosimeter. At the end of this mixing time, beads including those in the 16×20 mesh size range had formed. The product beads were air dried overnight prior to calcination using the shallow tray method at temperatures up to 593° C., as described in Example 1.

The products from examples 7-11 which showcase the use of different types of silicone reagents, as well as the practice of the invention using a different adsorbent, 4A zeolite, have been characterized by Hg porosimetry to confirm that the pore structure criteria of the present invention are met. The results are summarized in Table 4.

TABLE 4
Characterization Results for Examples 7-11

| | | | Binder | | | ¹% | ¹Hysteresis |
|---|---|---|---|---|---|---|---|
| | | Binder | Content | ¹Porosity | ¹MPD | Pores ≦ | Factor R |
| Example | Active | Type | (%) | (%) | (μm) | 0.1 μm | (Dim.) |
| 7 | NaKLSX | MR-2404 | 5 | 36.0 | 0.54 | 7.8 | 0.8 |
| 8 | NaKLSX | BS45 | 7 | 43.2 | 0.60 | 7.0 | 0.8 |
| 9 | NaKLSX | 233 Flake | 7 | 53.4 | 0.85 | 6.2 | 0.6 |
| 10 | NaKLSX | 233 Flake | 7 | 47.1 | 0.86 | 8.1 | 0.8 |
| 11 | 4A | IE-2404 | 5 | 33.8 | 0.47 | 8.9 | 0.5 |

¹Porosity, median pore diameter (MPD), % pores ≦ 0.1 μm and hysteresis factor are determined as described above from Hg porosimetry data.

The data in Table 4 show that the differentiated pore structure characteristics of the present invention are obtained with different types and forms of the silicone binders. The results in Table 4 also show that these characteristics are applicable to different adsorbent types.

It should be apparent to those skilled in the art that the subject invention is not limited by the examples provided herein which have been provided to merely demonstrate the operability of the present invention. The selection of appropriate adsorbent components and processes for use can be determined from the specification without departing from the spirit of the invention as herein disclosed and described. The scope of this invention includes equivalent embodiments, modifications, and variations that fall within the scope of the attached claims.

1. An adsorbent composition prepared by the heat treatment of a mixture comprising at least one active material and a silicone-derived binding agent to form agglomerated particles containing 90% or more of the at least one active material calculated on a dry weight final product basis and having a crush strength value of greater than that obtained from the value determined by the relationship y=1.2x−0.2 where y is the mean crush strength in lbF and x is the mean particle size in mm.

2. The composition of claim 1 wherein the at least one active component is one or more aluminosilicates, aluminas, and silicas.

3. The composition of claim 1 wherein the at least one active material is one or more zeolites.

4. The composition of claim 3 wherein the one or more zeolites includes a zeolite having a silica to alumina ratio of less than or equal to 2.5.

5. The composition of claim 4 wherein the zeolite is a LiX zeolite.

6. The composition of claim 1 wherein the silicone-derived binding agent is derived from a silicone binder precursor of the general formula [R2SiO]n, where R is one or more organic side groups selected from C1 to C8 organic compounds, including linear, branched and cyclic compounds or mixtures thereof and wherein the polymeric or oligomeric silicones are terminated by hydroxy, methoxy, ethoxy groups or mixtures thereof.

7. The composition of claim 6 wherein the silicone binder precursor is selected from an hydroxy, methoxy, or ethoxy terminated polymeric
di-methylsiloxane or mixtures thereof with methyl-silsesquioxanes, octyl-silsesquioxanes, methyl octyl-silsesquioxanes, or mixtures thereof.

8. The composition of claim 6 wherein the silicone binder precursor is a di-methylsiloxane with the CAS Registry Number of 897393-56-5.

9. The composition of claim 1 wherein the agglomerated particles have a hysteresis factor of equal to or greater than 0.5.

10. The composition of claim 1 wherein the agglomerated particles have a pore structure defined by a median pore diameter of equal to or greater than 0.45 μm and 10% or less of the macropores and mesopores of the agglomerated particles are of less than or equal to 0.1 μm.

11. The composition of claim 1 wherein the agglomerated particles has 93% or more of the at least one active material calculated on a dry weight final product basis.

12. The composition of claim 11 wherein the agglomerated particles has 95% or more of the at least one active material calculated on a dry weight final product basis.

13. An adsorption process for separating a less strongly adsorbable component from a fluid mixture containing at least one less strongly adsorbable component and at least one more strongly adsorbable component comprising contacting the fluid mixture with an adsorbent composition which selectively adsorbs the at least one more strongly adsorbable component and the at least one less strongly adsorbable component is recovered as product; the adsorbent composition comprising agglomerated particles of at least one active component bound together by a silicone-derived binding agent and wherein 90% or more of the active component is present calculated on a dry weight final product basis and the composition has a crush strength value of greater than that obtained from the value determined by the relationship y=1.2x−0.2 where y is the mean crush strength in lbF and x is the mean particle size in mm.

14. The adsorption process of claim 13 wherein the process is a cyclic adsorption process for the separation of gases.

15. The adsorption process of claim 14 wherein the process is a VSA, TSA, PSA, and VPSA process.

16. The adsorption process of claim 13 wherein the at least one active component is one or more zeolites.

17. The adsorption process of claim 16 wherein the one or more zeolites include a zeolite having a silica to alumina ratio of less than 15.

18. The adsorption process of claim 16 wherein the one or more zeolites include a zeolite having a silica to alumina ratio of less than or equal to 2.5.

19. The adsorption process of claim 15 wherein the active component is a LiLSX zeolite.

20. The adsorption process of claim 13 wherein the silicone-derived binding agent is derived from a silicone binder precursor of the general formula [R2SiO]n, where R is one or more organic side groups selected from C1 to C8 organic compounds, including linear, branched and cyclic compounds or mixtures thereof and wherein the polymeric or oligomeric silicones are terminated by hydroxy, methoxy, ethoxy groups or mixtures thereof.

21. The composition of claim 20 wherein the silicone binder precursor is selected from an hydroxy, methoxy, or ethoxy terminated polymeric
di-methylsiloxane or mixtures thereof with methyl-silsesquioxanes, octyl-silsesquioxanes, methyl octyl-silsesquioxanes, or mixtures thereof.

22. The adsorption process of claim 13 wherein the adsorbent composition has 93% or more of the active material calculated on a dry weight final product basis.

23. The adsorption process of claim 13 wherein the adsorbent composition has 95% or more of the active material calculated on a dry weight final product basis.

24. An agglomerated adsorbent composition useful in adsorption, separation, and purification processes prepared by the process of mixing a composition comprising at least one active component selected from one or more aluminosilicates and a silicone binder precursor containing organic side groups on an silicon-oxide backbone to make a mixture, forming the mixture into agglomerated particles, and subjecting the agglomerated particles to a thermal heat treatment sufficient to volatize at least part of the organic side groups to form a silicone-derived binding agent, wherein the silicone-derived binding agent is present in the final agglomerated adsorbent composition in an amount of 10% or less calculated on a dry weight final product basis.

25. The composition of claim 24 wherein the adsorbent preparation process contains the step of ion exchange.

26. The composition of claim 24 having a crush strength value of greater than the value determined by the relationship y=1.2x−0.2 where y is the mean crush strength in lbF and x is the mean particle size in mm.

27. The adsorbent composition of claim 24 wherein the adsorbent comprises crystallite particles in the form of agglomerated particles having an average particle size of 0.4 to 5.0 mm, a pore structure defined by a median pore diameter of equal to or greater than 0.45 μm, and a hysteresis factor of equal to or greater than 0.5.

28. The adsorbent composition of claim 24 wherein the silicone-derived binding agent is present in an amount of 7% or less calculated on a dry weight final product basis.

29. An adsorbent composition comprising agglomerated crystallite zeolite particles bound with a silicone-derived binding agent made by the calcination of a mixture comprising at least the crystallite zeolite particles with a silicone binder precursor, the composition having substantially no visible silicone-derived binding agent in the pores of the agglomerated particles when viewed under a SEM at 4500× magnification.

30. The adsorbent composition of claim 29 wherein the silicone-derived binding agent is present in an amount of 10% or less calculated on a dry weight final product basis.

31. The adsorbent composition of claim 31 wherein the silicone-derived binding agent is derived from a silicone binder precursor of the general formula [R2SiO]n, where R is one or more organic side groups selected from C1 to C8 organic compounds, including linear, branched and cyclic compounds or mixtures thereof and wherein the polymeric or oligomeric silicones are terminated by hydroxy, methoxy, ethoxy groups or mixtures thereof.

32. The adsorbent composition of claim 29 wherein the zeolite is a LiX zeolite.

34. The adsorbent composition of claim 29 wherein the silicone-derived binding agent is present in an amount of 7% or less calculated on a dry weight final product basis.

35. An adsorbent composition prepared using a calcination step comprising agglomerated particles of one or more aluminosilicates bound with 10% or less of a silicone-derived binding agent as calculated on a final product dry weight basis.

36. The adsorbent composition of claim 35 characterized by:
a median pore diameter of equal to or greater than 0.45 μm,
10% or less of the macropores and mesopores are of less than or equal to 0.1 μm,
a hysteresis factor of equal to or greater than 0.5, and
a crush strength value of greater than that obtained from the value determined by the relationship y=1.2x−0.2 where y is the mean crush strength in lbF and x is the mean particle size in mm.

37. The adsorbent composition of claim 35 wherein the silicone-derived binding agent is present in an amount of 7% or less calculated on a dry weight final product basis.

38. The adsorbent composition of claim 35 wherein the silicone-derived binding agent is present in an amount of 5% or less calculated on a dry weight final product basis.

39. The composition of claim 35 wherein the one or more aluminosilicates is selected from one or more zeolites.

40. The adsorption process of claim 39 wherein the one or more zeolites include a zeolite having an exchanged cation.

41. The adsorption process of claim 40 wherein the one or more zeolites include a zeolite having a silica to alumina ratio of less than or equal to 2.5.

42. The adsorption process of claim 40 wherein the zeolite is a LiLSX zeolite.

43. The composition of claim 35 wherein the silicone-derived binding agent is derived from a silicone binder precursor of the general formula [R2SiO]n, where R is one or more organic side groups selected from C1 to C8 organic compounds, including linear, branched and cyclic compounds or mixtures thereof and wherein the polymeric or oligomeric silicones are terminated by hydroxy, methoxy, ethoxy groups or mixtures thereof.

44. The composition of claim 43 wherein the silicone binder precursor is selected from an hydroxy, methoxy, or ethoxy terminated polymeric
di-methylsiloxane or mixtures thereof with methyl-silsesquioxanes, octyl-silsesquioxanes, methyl octyl-silsesquioxanes, or mixtures thereof.

45. The composition of claim 44 wherein the silicone binder precursor is a di-methylsiloxane with the CAS Registry Number of 897393-56-5.
